(19) United States
(12) Patent Application Publication
(10) Pub. No.: US 2026/0302965 A1
(43) Pub. Date: Oct. 1, 2026

(54) RECTIFYING AND FILTERING CIRCUIT, ELECTRONIC CIRCUIT, AND ELECTRONIC DEVICE

(71) Applicant: HUAYUAN SEMICONDUCTOR (SHENZHEN) LIMITED COMPANY, Shenzhen, Guangdong (CN)

(72) Inventors: Chunming GUO, Shenzhen, Guangdong (CN); Haibin XIAO, Shenzhen, Guangdong (CN)

(21) Appl. No.: 19/483,347

(22) PCT Filed: Jun. 6, 2024
(86) PCT No.: PCT/CN2024/097773

§ 371 Date: Nov. 11, 2025

(30) Foreign Application Priority Data
Jun. 6, 2023 (CN) 202310661440.0

(51) Int. Cl. H02M 7/12; H02M 1/15; H02M 7/219

(52) U.S. Cl. CPC H02M 7/125; H02M 1/15; H02M 7/219

(57) ABSTRACT

A circuit includes: a rectifying module, configured to rectify an input alternating-current voltage, output a first direct-current voltage; an energy storage assembly, configured to store energy under the action of the first direct-current voltage; a switching transistor, configured to control connection and isolation between the rectifying module and the energy storage assembly; a switch control module, configured to compare the first direct-current signal with a first reference signal, and control on and off of the switching transistor based on a comparison result, where the first direct-current signal is positively correlated with a second direct-current voltage, the first direct-current voltage is positively correlated with the second direct-current voltage, and the first reference signal is positively correlated with an upper withstand voltage limit of the energy storage assembly; and a surge protection module, configured to restrict a current flowing through the switching transistor within a first threshold.

### TECHNICAL FIELD

The present field relates to the field of power supply control, and in particular, to a rectifying and filtering circuit, an electronic circuit, and an electronic device.

### BACKGROUND

With the development of third-generation semiconductor devices and PD fast charging, power density of a switching power supply is required to be increasingly high. In this case, a volume of a high-voltage electrolytic capacitor positioned after a rectifier bridge becomes an important factor for reducing a volume of a charger/adapter, especially in markets such as India in which an ultra-high voltage input is allowed (a single-phase alternating-current input voltage may reach up to 350 V or even 420 V). In the prior art, it is often necessary to either customize an electrolytic capacitor with a withstand voltage above 500 V or connect a plurality of electrolytic capacitors in series to address an issue in terms of a withstand voltage of an energy storage electrolytic capacitor after rectification. However, this in turn limits reduction in a size of the power supply.

Referring to FIG. 1, for example, in the Chinese market, V_{ac}=264 V, and a rectified direct-current voltage Vᵢₙ=373 VDC. In this case, an electrolytic capacitor of 400 V can be used to address an energy storage issue after rectification. However, in the Indian market, V_{ac} may reach 350 V, and a rectified direct-current voltage Vᵢₙ=495 V. In this case, it is necessary to either customize an electrolytic capacitor with at least 500 V or connect two electrolytic capacitors with 400 V in series to address the energy storage issue after rectification. This, however, increases a volume and costs of the entire power supply.

### SUMMARY

Provided in the present invention are a rectifying and filtering circuit, an electronic circuit, and an electronic device, so that an energy storage assembly can bear an excess alternative-current input voltage.

According to a first aspect of the present invention, a rectifying and filtering circuit is provided and is configured to rectify and filter an alternating-current voltage, and the circuit includes:
a rectifying module, configured to: input the alternating-current voltage, rectify the alternating-current voltage, and output a first direct-current voltage from a first terminal of the rectifying module;
an energy storage assembly, coupled between the first terminal and a second terminal of the rectifying module, where the energy storage assembly is configured to store energy under the action of the first direct-current voltage, and the second terminal of the rectifying module is grounded;
a switching transistor, coupled between the energy storage assembly and the rectifying module, where the switching transistor is configured to control connection and isolation between the rectifying module and the energy storage assembly;
a switch control module, coupled to a gate of the switching transistor, where the switch control module is configured to: compare a first direct-current signal with a first reference signal, and control on and off of the switching transistor based on a comparison result, where the first direct-current signal is positively correlated with a second direct-current voltage, the first direct-current voltage is positively correlated with the second direct-current voltage, and the first reference signal is positively correlated with an upper withstand voltage limit of the energy storage assembly; and
a surge protection module, coupled between the switching transistor and the rectifying module, where the surge protection module is configured to restrict a current flowing through the switching transistor within a first threshold.

Optionally, the rectifying module includes a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the second terminal of the first rectifying unit;
the switch control module is coupled between the first terminal of the second rectifying unit and the gate of the switching transistor; and
the surge protection module is coupled between the switching transistor and the second terminal of the first rectifying unit.

Optionally, the rectifying module includes a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the first terminal of the first rectifying unit;
the switch control module is coupled between the first terminal of the second rectifying unit and the gate of the switching transistor; and
the surge protection module is coupled between the switching transistor and the first terminal of the first rectifying unit.

Optionally, the switch control module includes a first resistive unit, a second resistive unit, and a comparator;
a first terminal of the first resistive unit is connected to the first terminal of the second rectifying unit, and a second terminal of the first resistive unit is separately connected to an inverting input terminal of the comparator and a first terminal of the second resistive unit; a second terminal of the second resistive unit is grounded; and the first resistive unit and the second resistive unit are jointly configured to divide the second direct-current voltage, and output the first direct-current signal from the second terminal of the first resistive unit to the inverting input terminal of the comparator;
the first reference signal is input to a non-inverting input terminal of the comparator; and
the comparator is configured to compare the first reference signal with the first direct-current signal; if the first reference signal is greater than the first direct-current signal, the comparator outputs a high level to the gate of the switching transistor to turn on the switching transistor; and if the first reference signal is less than the first direct-current signal, the comparator outputs a low level to the gate of the switching transistor to turn off the switching transistor.

Optionally, the switch control module further includes a third resistive unit, a fourth resistive unit, and a fifth resistive unit;
a first terminal of the third resistive unit is connected to the first reference signal, and a second terminal of the third resistive unit is separately connected to the non-inverting input terminal of the comparator, a first terminal of the fourth resistive unit, and a first terminal of the fifth resistive unit;
a second terminal of the fourth resistive unit is connected to an output terminal of the comparator; and
a second terminal of the fifth resistive unit is grounded; where
the third resistive unit, the fourth resistive unit, and the fifth resistive unit are jointly configured to divide a voltage of the first reference signal, and are configured to change the comparator into a hysteresis comparator.

Optionally, the switch control module further includes a sixth resistive unit; and
the sixth resistive unit is coupled between the output terminal of the comparator and the gate of the switching transistor.

Optionally, the surge protection module includes a seventh resistive unit and a first transistor;
a first terminal of the seventh resistive unit is separately connected to the first terminal of the switching transistor and a base of the first transistor, and a second terminal of the seventh resistive unit is separately connected to the second terminal or the first terminal of the first rectifying unit and a first terminal of the first transistor;
a second terminal of the first transistor is connected to the gate of the switching transistor; and
if a current flowing through the sixth resistive unit exceeds the first threshold, the first transistor is turned on, so that the current flowing through the sixth resistive unit is restricted within the first threshold.

Optionally, the surge protection module further includes an eighth resistive unit; and
the eighth resistive unit is coupled between the first terminal of the switching transistor and the base of the first transistor.

Optionally, the first resistive unit to the eighth resistive unit each specifically include a resistor network.

Optionally, the rectifying module includes a first rectifying unit, a first terminal of the first rectifying unit is used as the first terminal of the rectifying module, a second terminal of the first rectifying unit is used as the second terminal of the rectifying module, and the first rectifying unit is configured to rectify the input alternating-current voltage, and output the first direct-current voltage from the first terminal;
the energy storage assembly is coupled between the first terminal and the second terminal of the first rectifying unit;
the switching transistor is coupled between the energy storage assembly and the second terminal of the first rectifying unit;
the switch control module is coupled between the first terminal of the first rectifying unit and the gate of the switching transistor, where the first direct-current voltage is the same as the second direct-current voltage;
the surge protection module is coupled between the switching transistor and the second terminal of the first rectifying unit; and
the rectifying and filtering circuit further includes a first diode unit, a positive electrode of the first diode unit is coupled to the first terminal of the rectifying module, and a negative electrode of the first diode unit is coupled to a first terminal of the energy storage assembly.

Optionally, the rectifying module includes a first rectifying unit, a first terminal of the first rectifying unit is used as the first terminal of the rectifying module, a second terminal of the first rectifying unit is used as the second terminal of the rectifying module, and the first rectifying unit is configured to rectify the input alternating-current voltage, and output the first direct-current voltage from the first terminal;
the energy storage assembly is coupled between the first terminal and the second terminal of the first rectifying unit;
the switching transistor is coupled between the energy storage assembly and the first terminal of the first rectifying unit;
the switch control module is coupled between the first terminal of the first rectifying unit and the gate of the switching transistor, where the first direct-current voltage is the same as the second direct-current voltage;
the surge protection module is coupled between the switching transistor and the first terminal of the first rectifying unit; and
the rectifying and filtering circuit further includes a first diode unit, a positive electrode of the first diode unit is coupled to the first terminal of the rectifying module, and a negative electrode of the first diode unit is coupled to a first terminal of the energy storage assembly.

Optionally, the switch control module includes a first resistive unit, a second resistive unit, and a comparator; and
a first terminal of the first resistive unit is connected to the first terminal of the first rectifying unit, a second terminal of the first resistive unit is respectively connected to an inverting input terminal of the comparator and a first terminal of the second resistive unit, and a second terminal of the second resistive unit is grounded.

Optionally, the first diode unit specifically includes a first diode.

According to a second aspect of the present invention, an electronic circuit is provided and includes the rectifying and filtering circuit according to the first aspect and optional solutions of the present invention.

According to a third aspect of the present invention, an electronic device is provided and includes the electronic circuit according to the second aspect of the present invention.

According to the rectifying and filtering circuit provided in the present invention, the switch control module compares the first direct-current voltage that is obtained after division, that is, the first direct-current signal, with the first reference signal; if the first reference signal is greater than the first direct-current signal, the comparator outputs a high level to turn on the switching transistor, so that the energy storage assembly is connected to the rectifying module, to indicate that the first direct-current voltage does not exceed the upper withstand voltage limit of the energy storage assembly in this case; and if the first reference signal is less than the first direct-current signal, the comparator outputs a low level to turn off the switching transistor, so that the energy storage assembly is isolated from the rectifying module, to indicate that the first direct-current voltage exceeds the upper withstand voltage limit of the energy storage assembly in this case. In the foregoing manner, the energy storage assembly bears the first direct-current voltage that exceeds a rated withstand voltage value of the energy storage assembly, so that a common voltage-withstanding energy storage assembly can rectify and filter a high alternating-current voltage. In addition, when the switching transistor is turned on, the surge protection module restricts a current flowing through the switching transistor within the first threshold to prevent the switching transistor from being broken down by a high current.

### BRIEF DESCRIPTION OF DRAWINGS

FIG. 1 shows a rectifying and filtering circuit in the prior art;

FIG. 2 is a block diagram 1 of a circuit structure of a rectifying and filtering circuit according to an embodiment of the present invention;

FIG. 3 is a schematic diagram 1 of a circuit structure of a rectifying and filtering circuit according to an embodiment of the present invention;

FIG. 4 is a schematic diagram 2 of a circuit structure of a rectifying and filtering circuit according to an embodiment of the present invention;

FIG. 5 is a schematic diagram 3 of a circuit structure of a rectifying and filtering circuit according to an embodiment of the present invention;

FIG. 6 is a schematic diagram 4 of a circuit structure of a rectifying and filtering circuit according to an embodiment of the present invention;

FIG. 7 is a block diagram 2 of a circuit structure of a rectifying and filtering circuit according to an embodiment of the present invention;

FIG. 8 is a block diagram 3 of a circuit structure of a rectifying and filtering circuit according to an embodiment of the present invention; and

FIG. 9 is a waveform diagram of an alternating-current voltage, a first direct-current voltage, and a second direct-current voltage according to an embodiment of the present invention.

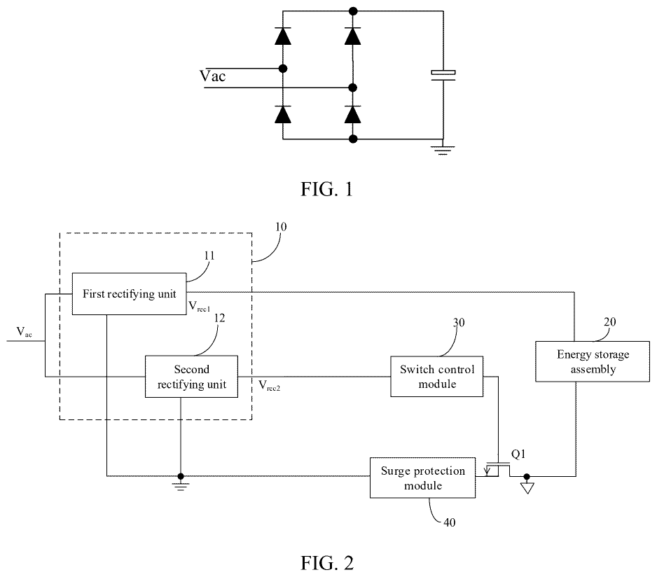

### BRIEF DESCRIPTION OF DRAWINGS

10—Rectifying module;
11—First rectifying unit;
12—Second rectifying unit;
20—Energy storage assembly;
30—Switch control module;
40—Surge protection module;
50—First diode unit;
V_{ac}—Alternating-current voltage;
V_{rec1}—First direct-current voltage;
V_{rec2}—Second direct-current voltage;
V_{ref}—First reference signal;
D1—First diode;
D2—Second diode;
D3—Third diode;
D4—Fourth diode;
D5—Fifth diode;
D6—Sixth diode;
D7—Seventh diode;
R1—First resistive unit;
R2—Second resistive unit;
R3—Third resistive unit;
R4—Fourth resistive unit;
R5—Fifth resistive unit;
R6—Sixth resistive unit;
R7—Seventh resistive unit;
R8—Eighth resistive unit;
U1—Comparator;
Q1—Switching transistor;
Q2—First transistor.

### DESCRIPTION OF EMBODIMENTS

The following clearly and completely describes the technical solutions in the embodiments of the present invention with reference to the accompanying drawings in the embodiments of the present invention. Obviously, the described embodiments are merely some but not all of embodiments of the present invention. Based on the embodiments of the present invention, all other embodiments obtained by those of ordinary skill in the art without creative efforts should fall within the protection scope of the present invention. The terms “first”, “second”, “third”, “fourth”, and the like (if they exist) in the specification and claims of the present invention are used to distinguish between similar objects instead of describing a specific sequence or order. It should be understood that the terms used in this way may be interchanged where appropriate, so that the embodiments of the present invention described herein can be implemented in a sequence other than what is illustrated or described herein. Furthermore, the terms “comprise” and “include” and any variations thereof are intended to cover a non-exclusive inclusion, such that a process, method, system, product or device that includes a list of steps or units does not include only those steps or units, but may include other steps or units not explicitly listed or inherent to such process, method, product, or device.

An embodiment of the present invention provides a rectifying and filtering circuit, configured to rectify and filter an alternating-current voltage. The circuit includes:
a rectifying module, configured to: input the alternating-current voltage, rectify the alternating-current voltage, and output a first direct-current voltage from a first terminal of the rectifying module;
an energy storage assembly, coupled between the first terminal and a second terminal of the rectifying module, where the energy storage assembly is configured to store energy under the action of the first direct-current voltage, and the second terminal of the rectifying module is grounded;
a switching transistor, coupled between the energy storage assembly and the rectifying module, where the switching transistor is configured to control connection and isolation between the rectifying module and the energy storage assembly;
a switch control module, coupled to a gate of the switching transistor, where the switch control module is configured to: compare a first direct-current signal with a first reference signal, and control on and off of the switching transistor based on a comparison result, where the first direct-current signal is positively correlated with a second direct-current voltage, the first direct-current voltage is positively correlated with the second direct-current voltage, and the first reference signal is positively correlated with an upper withstand voltage limit of the energy storage assembly; and
a surge protection module, coupled between the switching transistor and the rectifying module, where the surge protection module is configured to restrict a current flowing through the switching transistor within a first threshold.

### Embodiment 1

Referring to FIG. 2, a rectifying module 10 provided in Embodiment 1 includes a first rectifying unit 11 and a second rectifying unit 12. A first terminal of the first rectifying unit 11 is used as a first terminal of the rectifying module 10, and a second terminal of the first rectifying unit 11 and a second terminal of the second rectifying unit 12 are both used as a second terminal of the rectifying module 10. Both the first rectifying unit 11 and the second rectifying unit 12 are configured to rectify an input alternating-current voltage V_{ac} and respectively output a first direct-current voltage V_{rec1} and a second direct-current voltage V_{rec2} from respective first terminals.

An energy storage assembly 20 is coupled between the first terminal and the second terminal of the first rectifying unit 11.

A switching transistor Q1 is coupled between the energy storage assembly 20 and the second terminal of the first rectifying unit 11.

A switch control module 30 is coupled between the first terminal of the second rectifying unit 12 and a gate of the switching transistor Q1.

A surge protection module 40 is coupled between the switching transistor Q1 and the second terminal of the first rectifying unit 11.

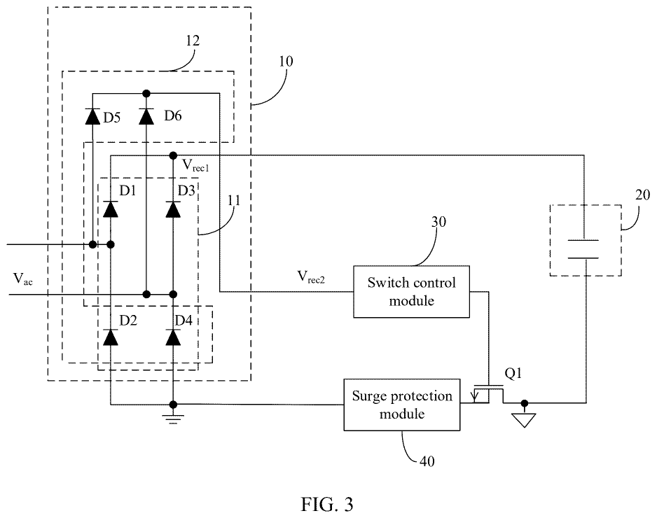

Referring to FIG. 3, in a specific implementation, both the first rectifying unit 11 and the second rectifying unit 12 are specifically bridge rectifying circuits; negative terminals of a first diode D1 and a third diode D3 of the first rectifying unit 11 are used as the first terminal of the first rectifying unit 11, and output the first direct-current voltage V_{rec1}; and negative terminals of a fifth diode D5 and a sixth diode D6 of the second rectifying unit 12 are used as the first terminal of the second rectifying unit 12, and output the second direct-current voltage V_{rec2}; and the first rectifying unit 11 and the second rectifying unit 12 share a second diode D2 and a fourth diode D4. Both the first direct-current voltage V_{rec1} and the second direct-current voltage V_{rec2} are pulsating direct-current voltages that are output after the alternating-current voltage V_{ac} is rectified by the first rectifying unit 11 and the second rectifying unit 12. Because both terminals of the first rectifying unit 11 are connected to the energy storage assembly 20, original ripples in the first direct-current voltage V_{rec1} are filtered out. Referring to FIG. 9, FIG. 9 is a waveform diagram of the alternating-current voltage V_{ac}, the first direct-current voltage V_{rec1}, and the second direct-current voltage V_{rec2}.

Referring to FIG. 3, in a specific implementation, the energy storage assembly 20 is specifically an electrolytic capacitor, and is configured to store energy under the action of the first direct-current voltage V_{rec1}, and an upper withstand voltage limit of the electrolytic capacitor is lower than a peak voltage of the first direct-current voltage V_{rec1}.

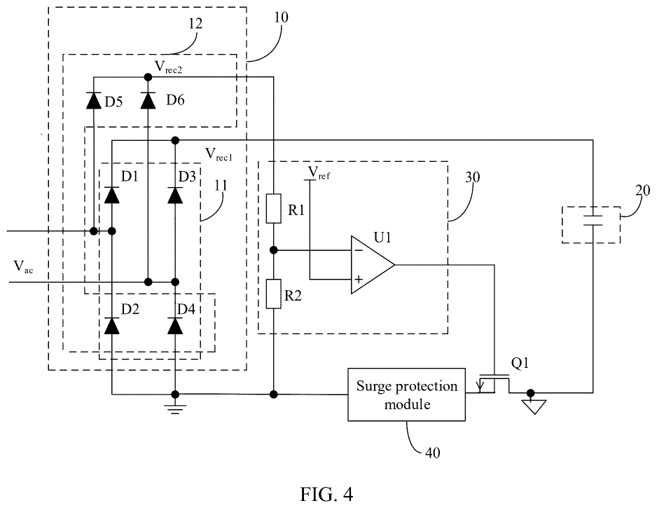

Referring to FIG. 4, in a specific implementation, the switch control module 30 specifically includes a first resistive unit R1, a second resistive unit R2, and a comparator U1.

A first terminal of the first resistive unit R1 is connected to the first terminal of the second rectifying unit 12, and a second terminal of the first resistive unit R1 is separately connected to an inverting input terminal of the comparator U1 and a first terminal of the second resistive unit R2; a second terminal of the second resistive unit R2 is grounded; the first resistive unit R1 and the second resistive unit R2 are jointly configured to divide the second direct-current voltage V_{rec2}, and output the first direct-current signal to the inverting input terminal of the comparator U1 from the second terminal of the first resistive unit R1; and a first reference signal V_{ref} is input to a non-inverting input terminal of the comparator U1. The first reference signal V_{ref} is specifically a voltage signal, and a voltage size is approximately several volts, and a specific size is positively correlated with the upper withstand voltage limit of the energy storage assembly 20, which is not limited herein; but the second direct-current voltage V_{rec2} is obtained after rectifying by using an alternating current that is input by a power grid, and a voltage size is within hundreds of volts. Therefore, the second direct-current voltage V_{rec2} is divided by using the first resistive unit R1 with a large resistance value, so that a value of the second direct-current voltage V_{rec2} is at a same level as the first reference signal V_{ref}, that is, the first direct-current signal.

The comparator is U1 configured to compare the first reference signal V_{ref} with the first direct-current signal; if the first reference signal V_{ref} is greater than the first direct-current signal, the comparator U1 outputs a high level to the gate of the switching transistor Q1 to turn on the switching transistor Q1; and if the first reference signal V_{ref} is less than the first direct-current signal, the comparator U1 outputs a low level to the gate of the switching transistor Q1 to turn off the switching transistor Q1. It may be learned from the foregoing description that the first reference signal V_{ref} may be used to represent the upper withstand voltage limit of the energy storage assembly 20, and the first direct-current signal may be used to represent the second direct-current voltage V_{rec2}, that is, may represent the first direct-current voltage V_{rec1}. By comparing values of the first reference signal V_{ref} and the first direct-current signal, the comparator U1 can learn whether the first direct-current voltage V_{rec1} exceeds the upper withstand voltage limit of the energy storage assembly 20. If the first direct-current voltage V_{rec1} exceeds the upper withstand voltage limit of the energy storage assembly 20, the comparator U1 outputs a low level to turn off the switching transistor Q1, so that the energy storage assembly 20 is isolated from the first rectifying unit 11, thereby protecting the energy storage assembly 20. If the first direct-current voltage V_{rec1} does not exceed the upper withstand voltage limit of the energy storage assembly 20, the comparator U1 outputs a high level to turn on the switching transistor Q1, so that the energy storage assembly 20 is connected to the first rectifying unit 11, and the energy storage assembly 20 is normally charged and discharged. Through the foregoing technical means, it is possible for the energy storage assembly 20 to bear the excess first direct-current voltage V_{rec1}, that is, bear the excess alternating-current voltage V_{ac}, without connecting a plurality of energy storage assemblies 20 in series or using a high-voltage-withstanding energy storage assembly 20, thereby reducing a volume and costs of the entire rectifying and filtering circuit.

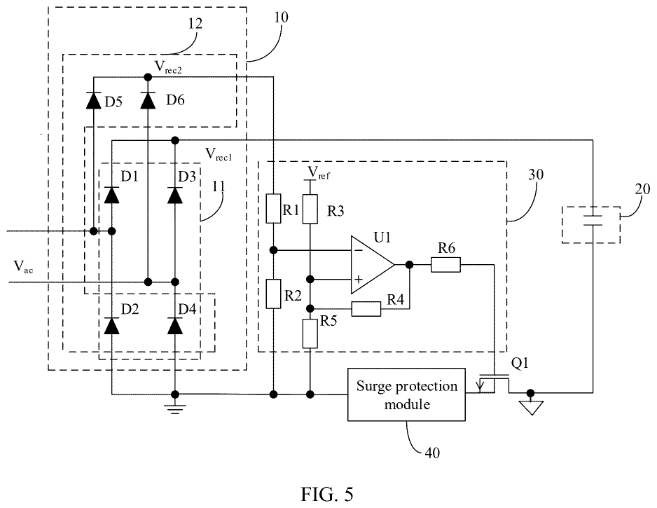

Referring to FIG. 5, in a specific implementation, the switch control module 30 further includes a third resistive unit R3, a fourth resistive unit R4, and a fifth resistive unit R5;
a first terminal of the third resistive unit R3 is connected to the first reference signal V_{ref}, and a second terminal of the third resistive unit R3 is separately connected to the non-inverting input terminal of the comparator U1, a first terminal of the fourth resistive unit R4, and a first terminal of the fifth resistive unit R5;
a second terminal of the fourth resistive unit R4 is connected to an output terminal of the comparator U1; and
a second terminal of the fifth resistive unit R5 is grounded; where
the third resistive unit R3, the fourth resistive unit R4, and the fifth resistive unit R5 are jointly configured to divide a voltage of the first reference signal V_{ref}, and are configured to change the comparator U1 into a hysteresis comparator. A beneficial effect is as follows: in a process of comparing the first reference signal V_{ref} with the first direct-current signal, a voltage margin is reserved for the comparator U1, so that the comparator U1 is not triggered by mistake. A specific principle is as follows: when the first direct-current signal is less than the first reference signal V_{ref}, the comparator U1 outputs a high level, and in this case, a voltage at the non-inverting input terminal of the comparator U1 is:

$$V + ( 1 ) = Vref \frac{R 4 // R 5}{R 3 + R 4 / / R 5} + VO \frac{R 3 // R 5}{R 4 + R 3 // R 5 ’} .$$

where V+(1) is used to represent a voltage at the non-inverting input terminal of the comparator U1 when the comparator U1 outputs a high level, V_{ref} is used to represent the first reference signal V_{ref}, R3, R4, and R5 are respectively used to represent the third resistive unit, the fourth resistive unit, and the fifth resistive unit, and VO is used to represent the high level output by the comparator U1.

When the first direct-current signal is greater than the first reference signal V_{ref}, the comparator U1 outputs a low level, and in this case, a voltage at the non-inverting input terminal of the comparator U1 is:

$$V + ( - ) = Vref \frac{R 4 // R 5}{R 3 + R 4 // R 5 ’} .$$

where V+(−) is used to represent a voltage at the non-inverting input terminal of the comparator U1 when the comparator U1 outputs a low level.

It may be learned from the foregoing formulas that when the comparator U1 needs to output a high level after outputting a low level, a voltage margin exists for the voltage at the non-inverting input terminal of the comparator U1, so as to ensure that the comparator U1 is not triggered by mistake due to an extra fluctuation of the first direct-current signal.

Referring to FIG. 5, in a specific implementation, the switch control module 30 further includes a sixth resistive unit R6, and the sixth resistive unit R6 is coupled between the output terminal of the comparator U1 and the gate of the switching transistor Q1.

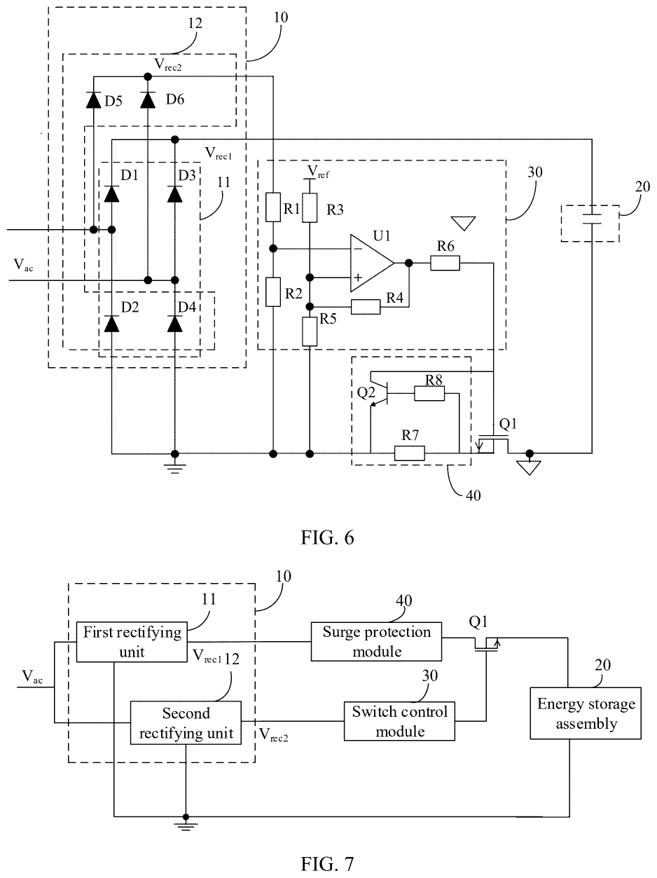

Referring to FIG. 6, in a specific implementation, the surge protection module 40 includes a seventh resistive unit R7 and a first transistor Q2;
a first terminal of the seventh resistive unit R7 is separately connected to the first terminal of the switching transistor Q1 and a base of the first transistor Q2, and a second terminal of the seventh resistive unit R7 is separately connected to the second terminal or the first terminal of the first rectifying unit 11 and a first terminal of the first transistor Q2; and
a second terminal of the first transistor Q2 is connected to the gate of the switching transistor Q1, where if a current flowing through the sixth resistive unit R6 exceeds the first threshold, the first transistor Q2 is turned on, so that the current flowing through the sixth resistive unit R6 is restricted within the first threshold. Specifically, in a process of turning on the switching transistor Q1, a current flows through the switching transistor Q1. When a current flowing through the seventh resistive unit R7 exceeds the first threshold, a voltage drop formed by the seventh resistive unit R7 turns on the first transistor Q2, so that the switching transistor Q1 works in an amplified state, preventing the switching transistor Q1 from being damaged due to an overcurrent. A value of the first threshold may be adjusted according to actual needs, and is not limited herein. The surge protection module 40 further includes an eighth resistive unit R8, and the eighth resistive unit R8 is coupled between the first terminal of the switching transistor Q1 and the base of the first transistor Q2, to limit a current flowing into the first transistor Q2, thereby protecting the first transistor Q2.

In a specific implementation, the first resistive unit R1 to the eighth resistive unit R8 each specifically include a resistor network, and the resistor network means that a plurality of resistor strings are connected in parallel. Certainly, the first resistive unit R1 to the eighth resistive unit R8 each may alternatively be only a single resistor, which is not limited herein.

### Embodiment 2

Referring to FIG. 7, a rectifying module 10 provided in Embodiment 1 includes a first rectifying unit 11 and a second rectifying unit 12. A first terminal of the first rectifying unit 11 is used as a first terminal of the rectifying module 10, and a second terminal of the first rectifying unit 11 and a second terminal of the second rectifying unit 12 are both used as a second terminal of the rectifying module 10. Both the first rectifying unit 11 and the second rectifying unit 12 are configured to rectify an input alternating-current voltage V_{ac} and respectively output a first direct-current voltage V_{rec1} and a second direct-current voltage V_{rec2} from respective first terminals.

An energy storage assembly 20 is coupled between the first terminal and the second terminal of the first rectifying unit 11.

A switching transistor Q1 is coupled between the energy storage assembly 20 and the first terminal of the first rectifying unit 11.

A switch control module 30 is coupled between the first terminal of the second rectifying unit 12 and a gate of the switching transistor Q1.

A surge protection module 40 is coupled between the switching transistor Q1 and the first terminal of the first rectifying unit 11.

A difference between Embodiment 2 and Embodiment 1 lies in that the switching transistor Q1 and the surge protection module 40 in Embodiment 2 are located at a high terminal of the rectifying and filtering circuit, and the switching transistor Q1 and the surge protection module 40 in Embodiment 1 are located at a low terminal of the rectifying and filtering circuit. Specific structures of the first rectifying unit 11, the second rectifying unit 12, the energy storage assembly 20, the switching transistor Q1, the switch control module 30, and the surge protection module 40 in Embodiment 2 are consistent with those in Embodiment 1. Details are not described herein again. However, in consideration of practicality, a drive circuit needs to be added between a gate and a source of the switching transistor Q1 in Embodiment 2, to improve a driving capability of the switching transistor Q1.

### Embodiment 3

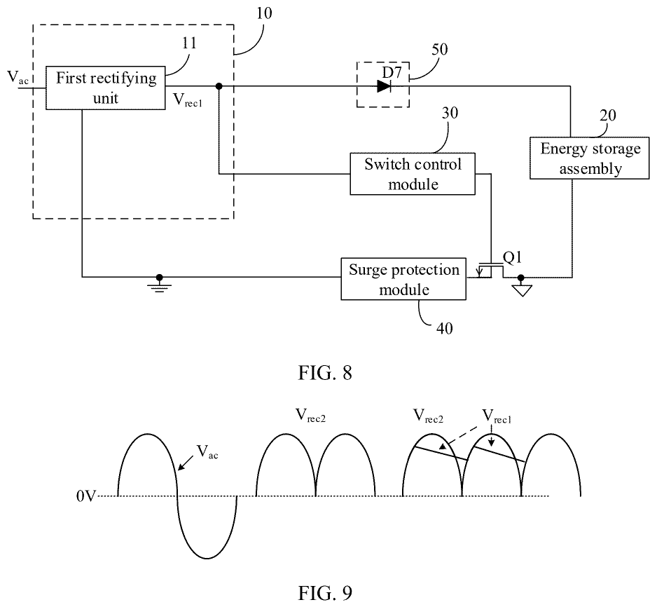

Referring to FIG. 8, a rectifying module 10 provided in Embodiment 3 includes a first rectifying unit 11. A first terminal of the first rectifying unit 11 is used as a first terminal of the rectifying module 10, and a second terminal of the first rectifying unit 11 is used as a second terminal of the rectifying module 10. The first rectifying unit 11 is configured to rectify an input alternating-current voltage V_{ac} and output a first direct-current voltage V_{rec1} from the first terminal.

An energy storage assembly 20 is coupled between the first terminal and the second terminal of the first rectifying unit 11.

A switching transistor Q1 is coupled between the energy storage assembly 20 and the second terminal of the first rectifying unit 11.

A switch control module 30 is coupled between the first terminal of the first rectifying unit 11 and a gate of the switching transistor Q1, and the first direct-current voltage V_{rec1} is the same as a second direct-current voltage V_{rec2}.

A surge protection module 40 is coupled between the switching transistor Q1 and the second terminal of the first rectifying unit 11.

The rectifying and filtering circuit further includes a first diode unit 50. A positive electrode of the first diode unit 50 is coupled to the first terminal of the rectifying module 10, and a negative electrode of the first diode unit 50 is coupled to a first terminal of the energy storage assembly 20.

In a specific implementation, the switch control module 30 includes a first resistive unit R1, a second resistive unit R2, and a comparator U1; and
a first terminal of the first resistive unit R1 is connected to the first terminal of the first rectifying unit 11, a second terminal of the first resistive unit R1 is respectively connected to an inverting input terminal of the comparator U1 and a first terminal of the second resistive unit R2, and a second terminal of the second resistive unit R2 is grounded.

In a specific implementation, the first diode unit 50 specifically includes a seventh diode D7. A function of the first diode unit 50 is to separate the first direct-current voltage V_{rec1} and a voltage at both terminals of the energy storage assembly 20.

A difference between Embodiment 3 and Embodiment 1 lies in that in Embodiment 1, the first direct-current voltage V_{rec1} output by the first rectifying unit 11 is used as a power voltage that supplies energy to the energy storage assembly 20, and the second direct-current voltage V_{rec2} output by the second rectifying unit 12 is used as a voltage of a signal to be compared with the first reference signal V_{ref}. In Embodiment 3, the first direct-current voltage V_{rec1} output by the first rectifying unit 11 is used as both a power voltage that supplies energy to the energy storage assembly 20 and a voltage of a signal to be compared with the first reference signal V_{ref}. Therefore, the first diode unit 50 needs to separate the first direct-current voltage V_{rec1} and a voltage at both terminals of the energy storage assembly 20. Specific structures of the first rectifying unit 11, the energy storage assembly 20, the switching transistor Q1, the switch control module 30, and the surge protection module 40 in Embodiment 3 are the same as those in Embodiment 1. Details are not described herein again.

### Embodiment 4

A rectifying module 10 provided in Embodiment 4 includes a first rectifying unit 11. A first terminal of the first rectifying unit 11 is used as a first terminal of the rectifying module 10, and a second terminal of the first rectifying unit 11 is used as a second terminal of the rectifying module 10. The first rectifying unit 11 is configured to rectify an input alternating-current voltage V_{ac} and output a first direct-current voltage V_{rec1} from the first terminal.

An energy storage assembly 20 is coupled between the first terminal and the second terminal of the first rectifying unit 11.

A switching transistor Q1 is coupled between the energy storage assembly 20 and the first terminal of the first rectifying unit 11.

A switch control module 30 is coupled between the first terminal of the first rectifying unit 11 and a gate of the switching transistor Q1, and the first direct-current voltage V_{rec1} is the same as a second direct-current voltage V_{rec2}.

A surge protection module 40 is coupled between the switching transistor Q1 and the first terminal of the first rectifying unit 11. The rectifying and filtering circuit further includes a first diode unit 50. A positive electrode of the first diode unit 50 is coupled to the first terminal of the rectifying module 10, and a negative electrode of the first diode unit 50 is coupled to a first terminal of the energy storage assembly 20.

A difference between Embodiment 4 and Embodiment 3 is consistent with the difference between Embodiment 2 and Embodiment 1, and details are not described herein again. An accompanying drawing in Embodiment 4 is similar to FIG. 7.

An embodiment of the present invention further provides an electronic circuit, including the rectifying and filtering circuit provided in the foregoing embodiments and optional embodiments of the present invention.

An embodiment of the present invention further provides an electronic device, including the electronic circuit.

Finally, it should be noted that the foregoing embodiments are merely intended for describing the technical solutions of the present invention rather than limiting the present invention. Although the present invention is described in detail with reference to the foregoing embodiments, those of ordinary skill in the art should understand that they may still make modifications to the technical solutions described in the foregoing embodiments or make equivalent replacements to some or all technical features thereof, without departing from the scope of the technical solutions of the embodiments of the present invention.

1. A rectifying and filtering circuit, configured to rectify and filter an alternating-current voltage, wherein the circuit comprises:
a rectifying module, configured to: input the alternating-current voltage, rectify the alternating-current voltage, and output a first direct-current voltage from a first terminal of the rectifying module;
an energy storage assembly, coupled between the first terminal and a second terminal of the rectifying module, wherein the energy storage assembly is configured to store energy under the action of the first direct-current voltage, and the second terminal of the rectifying module is grounded;
a switching transistor, coupled between the energy storage assembly and the rectifying module, wherein the switching transistor is configured to control connection and isolation between the rectifying module and the energy storage assembly;
a switch control module, coupled to a gate of the switching transistor, wherein the switch control module is configured to: compare a first direct-current signal with a first reference signal, and control on and off of the switching transistor based on a comparison result, wherein the first direct-current signal is positively correlated with a second direct-current voltage, the first direct-current voltage is positively correlated with the second direct-current voltage, and the first reference signal is positively correlated with an upper withstand voltage limit of the energy storage assembly; and
a surge protection module, coupled between the switching transistor and the rectifying module, wherein the surge protection module is configured to restrict a current flowing through the switching transistor within a first threshold.

2. The rectifying and filtering circuit according to claim 1, wherein the rectifying module comprises a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the second terminal of the first rectifying unit;
the switch control module is coupled between the first terminal of the second rectifying unit and the gate of the switching transistor; and
the surge protection module is coupled between the switching transistor and the second terminal of the first rectifying unit.

3. The rectifying and filtering circuit according to claim 1, wherein the rectifying module comprises a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the first terminal of the first rectifying unit;
the switch control module is coupled between the first terminal of the second rectifying unit and the gate of the switching transistor; and
the surge protection module is coupled between the switching transistor and the first terminal of the first rectifying unit.

4. The rectifying and filtering circuit according to claim 2, wherein the switch control module comprises a first resistive unit, a second resistive unit, and a comparator;
a first terminal of the first resistive unit is connected to the first terminal of the second rectifying unit, and a second terminal of the first resistive unit is separately connected to an inverting input terminal of the comparator and a first terminal of the second resistive unit; a second terminal of the second resistive unit is grounded; and the first resistive unit and the second resistive unit are jointly configured to divide the second direct-current voltage, and output the first direct-current signal from the second terminal of the first resistive unit to the inverting input terminal of the comparator;
the first reference signal is input to a non-inverting input terminal of the comparator; and
the comparator is configured to compare the first reference signal with the first direct-current signal; if the first reference signal is greater than the first direct-current signal, the comparator outputs a high level to the gate of the switching transistor to turn on the switching transistor; and if the first reference signal is less than the first direct-current signal, the comparator outputs a low level to the gate of the switching transistor to turn off the switching transistor.

5. The rectifying and filtering circuit according to claim 4, wherein the switch control module further comprises a third resistive unit, a fourth resistive unit, and a fifth resistive unit;
a first terminal of the third resistive unit is connected to the first reference signal, and a second terminal of the third resistive unit is separately connected to the non-inverting input terminal of the comparator, a first terminal of the fourth resistive unit, and a first terminal of the fifth resistive unit;
a second terminal of the fourth resistive unit is connected to an output terminal of the comparator; and
a second terminal of the fifth resistive unit is grounded; wherein
the third resistive unit, the fourth resistive unit, and the fifth resistive unit are jointly configured to divide a voltage of the first reference signal, and are configured to change the comparator into a hysteresis comparator.

6. The rectifying and filtering circuit according to claim 5, wherein the switch control module further comprises a sixth resistive unit; and
the sixth resistive unit is coupled between the output terminal of the comparator and the gate of the switching transistor.

7. The rectifying and filtering circuit according to claim 6, wherein the surge protection module comprises a seventh resistive unit and a first transistor;
a first terminal of the seventh resistive unit is separately connected to the first terminal of the switching transistor and a base of the first transistor, and a second terminal of the seventh resistive unit is separately connected to the second terminal or the first terminal of the first rectifying unit and a first terminal of the first transistor;
a second terminal of the first transistor is connected to the gate of the switching transistor; and
if a current flowing through the sixth resistive unit exceeds the first threshold, the first transistor is turned on, so that the current flowing through the sixth resistive unit is restricted within the first threshold.

8. The rectifying and filtering circuit according to claim 7, wherein the surge protection module further comprises an eighth resistive unit; and
the eighth resistive unit is coupled between the first terminal of the switching transistor and the base of the first transistor.

9. The rectifying and filtering circuit according to claim 8, wherein the first resistive unit to the eighth resistive unit each specifically comprise a resistor network.

10. The rectifying and filtering circuit according to claim 1, wherein
the rectifying module comprises a first rectifying unit, a first terminal of the first rectifying unit is used as the first terminal of the rectifying module, a second terminal of the first rectifying unit is used as the second terminal of the rectifying module, and the first rectifying unit is configured to rectify the input alternating-current voltage, and output the first direct-current voltage from the first terminal;
the energy storage assembly is coupled between the first terminal and the second terminal of the first rectifying unit;
the switching transistor is coupled between the energy storage assembly and the second terminal of the first rectifying unit;
the switch control module is coupled between the first terminal of the first rectifying unit and the gate of the switching transistor, wherein the first direct-current voltage is the same as the second direct-current voltage;
the surge protection module is coupled between the switching transistor and the second terminal of the first rectifying unit; and
the rectifying and filtering circuit further comprises a first diode unit, a positive electrode of the first diode unit is coupled to the first terminal of the rectifying module, and a negative electrode of the first diode unit is coupled to a first terminal of the energy storage assembly.

11. The rectifying and filtering circuit according to claim 1, wherein
the rectifying module comprises a first rectifying unit, a first terminal of the first rectifying unit is used as the first terminal of the rectifying module, a second terminal of the first rectifying unit is used as the second terminal of the rectifying module, and the first rectifying unit is configured to rectify the input alternating-current voltage, and output the first direct-current voltage from the first terminal;
the energy storage assembly is coupled between the first terminal and the second terminal of the first rectifying unit;
the switching transistor is coupled between the energy storage assembly and the first terminal of the first rectifying unit;
the switch control module is coupled between the first terminal of the first rectifying unit and the gate of the switching transistor, wherein the first direct-current voltage is the same as the second direct-current voltage;
the surge protection module is coupled between the switching transistor and the first terminal of the first rectifying unit; and
the rectifying and filtering circuit further comprises a first diode unit, a positive electrode of the first diode unit is coupled to the first terminal of the rectifying module, and a negative electrode of the first diode unit is coupled to a first terminal of the energy storage assembly.

12. The rectifying and filtering circuit according to claim 10, wherein the switch control module comprises a first resistive unit, a second resistive unit, and a comparator; and
a first terminal of the first resistive unit is connected to the first terminal of the first rectifying unit, a second terminal of the first resistive unit is respectively connected to an inverting input terminal of the comparator and a first terminal of the second resistive unit, and a second terminal of the second resistive unit is grounded.

13. The rectifying and filtering circuit according to claim 12, wherein the first diode unit specifically comprises a first diode.

14. An electronic circuit, comprising the rectifying and filtering circuit according to claim 1.

15. An electronic device, comprising the electronic circuit according to claim 14.

16. The rectifying and filtering circuit according to claim 3, wherein the switch control module comprises a first resistive unit, a second resistive unit, and a comparator;
a first terminal of the first resistive unit is connected to the first terminal of the second rectifying unit, and a second terminal of the first resistive unit is separately connected to an inverting input terminal of the comparator and a first terminal of the second resistive unit; a second terminal of the second resistive unit is grounded; and the first resistive unit and the second resistive unit are jointly configured to divide the second direct-current voltage, and output the first direct-current signal from the second terminal of the first resistive unit to the inverting input terminal of the comparator;
the first reference signal is input to a non-inverting input terminal of the comparator; and
the comparator is configured to compare the first reference signal with the first direct-current signal; if the first reference signal is greater than the first direct-current signal, the comparator outputs a high level to the gate of the switching transistor to turn on the switching transistor; and if the first reference signal is less than the first direct-current signal, the comparator outputs a low level to the gate of the switching transistor to turn off the switching transistor.

17. The rectifying and filtering circuit according to claim 11, wherein the switch control module comprises a first resistive unit, a second resistive unit, and a comparator; and
a first terminal of the first resistive unit is connected to the first terminal of the first rectifying unit, a second terminal of the first resistive unit is respectively connected to an inverting input terminal of the comparator and a first terminal of the second resistive unit, and a second terminal of the second resistive unit is grounded.

18. The electronic circuit according to claim 14, wherein the rectifying module comprises a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the second terminal of the first rectifying unit;
the switch control module is coupled between the first terminal of the second rectifying unit and the gate of the switching transistor; and
the surge protection module is coupled between the switching transistor and the second terminal of the first rectifying unit.

19. The electronic circuit according to claim 14, wherein the rectifying module comprises a first rectifying unit and a second rectifying unit, a first terminal of the first rectifying unit is used as the first terminal of the rectifying module, a second terminal of the first rectifying unit and a second terminal of the second rectifying unit are both used as the second terminal of the rectifying module, and both the first rectifying unit and the second rectifying unit are configured to rectify the input alternating-current voltage and respectively output the first direct-current voltage and the second direct-current voltage from respective first terminals;
the energy storage assembly is coupled between the first terminal and the second terminal of the first rectifying unit;
the switching transistor is coupled between the energy storage assembly and the first terminal of the first rectifying unit;
the switch control module is coupled between the first terminal of the second rectifying unit and the gate of the switching transistor; and
the surge protection module is coupled between the switching transistor and the first terminal of the first rectifying unit.

20. The electronic circuit according to claim 18, wherein the switch control module comprises a first resistive unit, a second resistive unit, and a comparator;
a first terminal of the first resistive unit is connected to the first terminal of the second rectifying unit, and a second terminal of the first resistive unit is separately connected to an inverting input terminal of the comparator and a first terminal of the second resistive unit; a second terminal of the second resistive unit is grounded; and the first resistive unit and the second resistive unit are jointly configured to divide the second direct-current voltage, and output the first direct-current signal from the second terminal of the first resistive unit to the inverting input terminal of the comparator;
the first reference signal is input to a non-inverting input terminal of the comparator; and
the comparator is configured to compare the first reference signal with the first direct-current signal; if the first reference signal is greater than the first direct-current signal, the comparator outputs a high level to the gate of the switching transistor to turn on the switching transistor; and if the first reference signal is less than the first direct-current signal, the comparator outputs a low level to the gate of the switching transistor to turn off the switching transistor.
